(19) United States
(12) Patent Application Publication
(10) Pub. No.: US 2008/0144335 A1
(43) Pub. Date: Jun. 19, 2008

(54) LIGHT GUIDE PLATE AND BACKLIGHT MODULE INCLUDING THE SAME

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/843,665

(22) Filed: Aug. 23, 2007

(30) Foreign Application Priority Data
Dec. 13, 2006 (CN) 200610201286.5

(51) Int. Cl. F21V 8/00; F21V 7/04

(52) U.S. Cl. 362/620; 362/629

(57) ABSTRACT

An exemplary light guide plate configured for guiding light beams from a light source in order to uniformly illuminate a liquid crystal panel, includes an integrated transparent base plate having a bottom surface, and an light emitting top surface. A prism array is formed on the emitting surface, and a plurality of particles is evenly embedded in a layer in the middle of the light guide plate, the layer is in parallel with the bottom surface and the emitting surface. A backlight module including the light guide plate is also disclosed.

### BACKGROUND

1. Field of the Invention

The present invention relates to a backlight module, and particularly to a backlight module with a simplified structure.

2. Description of Related Art

A liquid crystal display is capable of displaying a clear and sharp image with millions of pixels elements. It has thus been applied to various devices in which a message or picture needs to be displayed, such as mobile phones and notebook computers. However, liquid crystal in the liquid crystal display does not itself emit light. Instead, the liquid crystal has to be lit up by a light source so as to clearly and sharply display text and images.

A conventional backlight module is represented in FIG. 2. The backlight module generally includes a housing 700 accommodating a light source 100, a reflector 200, a light guide plate 300, a diffusion plate 400, a lower brightness enhancement film 500, and an upper brightness enhancement film 600. The light source 100 can be a linear light source or a point light source. The light guide plate 300 is configured for receiving light beams from the light source 100, and for evenly distributing the light beams over the entire light guide plate 300 through reflection and diffusion. The reflector 200 is disposed under the light guide plate 300 for upwardly reflecting light beams from the light source 100 to the light guide plate 300. The diffusion plate 400 includes a substrate 410, and a plurality of particles 420 formed on the substrate 410, for providing greater light uniformity. The lower brightness enhancement film 500 includes a base plate 510 and a plurality of prisms 520 formed on the base plate 510. The lower brightness enhancement film 500, and the upper brightness enhancement film 600 are disposed on the diffusion plate 400 sequentially to increase a diffusion efficiency of the light transmitted from the light guide plate 300.

Employing a separate diffusion plate 400 and a lower brightness enhancement film 500 to increase the diffusion efficiency of the light also complicates the structure of the back light module and increases the cost of the conventional back light module.

What is needed, therefore, is a backlight module which not only provides high diffusion efficiency of the light, but also has a simplified structure which can be mass produced at a reasonable cost.

### SUMMARY

An exemplary light guide plate configured for guiding light beams from a light source in order to uniformly illuminate a liquid crystal panel, includes an integrated transparent base plate having a bottom surface, and a top surface functioning as an emitting surface. A prism array is formed on the emitting surface, and a plurality of particles is evenly embedded in a layer in the middle of the light guide plate, in parallel with the bottom surface and the emitting surface.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic side view of a backlight module in accordance with an embodiment of the present invention; and

FIG. 2 is a schematic side view of a conventional backlight module.

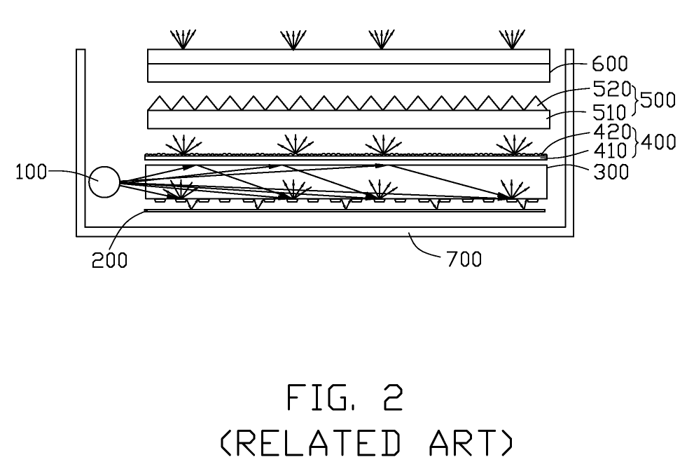

### DETAILED DESCRIPTION

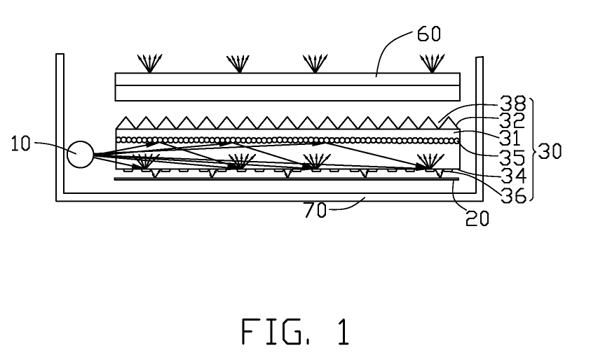

Referring to FIG. 1, a backlight module in accordance with an embodiment of the present invention includes a housing 70 accommodating a light source 10, a reflector 20, a light guide plate 30, and a brightness enhancement film 60 therein.

The light source 10 used in the backlight module can be a light emitting diode (LED), or a cold cathode fluorescent lamp (CCFL). The light source 10 can be a linear light source or a point light source. The light source 10 is located adjacent to a side surface of the light guide plate 30.

The light guide plate 30 is made of acrylic material to provide a uniformly reflecting surface for guiding light. The light guide plate 30 comprises an integrated base plate 31, and the base plate 31 comprises a bottom surface 34 on which a plurality of identical protrusions 36 are formed, a top surface acting as an emitting surface 32, and four side surfaces perpendicularly connected between the emitting surface 32 and the bottom surface 34. The protrusions 36 diffuse light beams coming from the light source 10, so that light beams are evenly emitted from the emitting surface 32. A particle layer is disposed in the middle of the light guide plate 30 for providing greater light uniformity. The particle layer is composed of transparent particles 35 with diameters preferably in the range from 1 nm˜10 mm. The particles 35 are uniformly sized and are made of polymethyl methacrylate (PMMA) or silicon dioxide. The emitting surface 32 defines a plurality of V-shaped grooves 38, and a triangular prism array is formed on the emitting surface 32. The triangular prisms all have a same width and a same height to provide light uniformity. The emitting surface 32 can comprise triangular prisms, or alternatively comprise an array of hemispherical diffusing protrusions.

The light guide plate 30 is configured for receiving light beams from the light source 10, and for evenly distributing the light beams over the entire light guide plate 30 through reflection and diffusion. The reflector 20 is disposed under the light guide plate 30 for upwardly reflecting light beams from the light source 10 to the light guide plate 30. The upper brightness enhancement film 60 is disposed on the light guide plate 30 to increase a diffusion efficiency of the light transmitted from the light guide plate 30.

The back light module including the guide light plate 30 reduces the usage of the conventional diffusion plate and the conventional lower brightness enhancement film, the cost and the vertical thickness of the back light module are thereby reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate configured for guiding light beams from a light source in order to uniformly illuminate a liquid crystal panel, comprising:
an integrated transparent base plate having a bottom surface, and a top surface acting as an emitting surface;
a prism array formed on the emitting surface; and
a particle layer comprising a plurality of particles evenly embedded within the transparent base plate, the layer in parallel with the bottom surface and the emitting surface.

2. The light guide plate as claimed in claim 1, wherein the prism array comprises a plurality of triangular prisms, and every two adjacent prisms cooperatively defining an elongated V-shaped groove therebetween.

3. The light guide plate as claimed in claim 1, wherein the prism array comprises a plurality of hemispherical diffusing protrusions.

4. The light guide plate as claimed in claim 1, wherein a plurality of identical protrusions are formed on the bottom surface of the base plate.

5. The light guide plate as claimed in claim 1, wherein diameters of the particles are in the range from 1 nm˜10 mm.

6. The light guide plate as claimed in claim 5, wherein the particles are uniformly sized and are made of polymethyl methacrylate.

7. The light guide plate as claimed in claim 5, wherein the particles are uniformly sized and are made of silicon dioxide.

8. A backlight module comprising:
a light guide plate comprising an integrated base plate having a bottom surface, a top surface acting as an emitting surface, a prism array formed on the emitting surface, and a particle layer comprising a plurality of transparent particles evenly embedded within the base plate, the layer in parallel with the bottom surface and the emitting surface;
a light source arranged at a side of the light guide plate, light beams from the light source entering the light guide plate via a side surface of the base plate connecting the top surface with the bottom surface; and
a housing arranged for accommodating the light guide plate and the light source therein.

9. The light guide plate as claimed in claim 8, wherein the prism array comprises a plurality of triangular prisms, and every two adjacent prisms cooperatively defining an elongated V-shaped groove therebetween.

10. The light guide plate as claimed in claim 8, wherein the prism array comprises a plurality of hemispherical diffusing protrusions.

11. The light guide plate as claimed in claim 8, wherein a plurality of identical protrusions are formed on the bottom surface of the base plate.

12. The light guide plate as claimed in claim 8, wherein diameters of the particles are in the range from 1 nm˜10 mm.

13. The light guide plate as claimed in claim 12, wherein the transparent particles are uniformly sized and are made of polymethyl methacrylate.

14. The light guide plate as claimed in claim 12, wherein the transparent particles are uniformly sized and are made of silicon dioxide.

15. The backlight module as claimed in claim 8, wherein the base plate is made of acrylic material.

16. The backlight module as claimed in claim 8, further comprising an upper brightness enhancement film disposed on the light guide plate.

17. The backlight module as claimed in claim 8, wherein a reflector is disposed under the light guide plate and accommodated in the housing.
